(19) United States
(12) Patent Application Publication
(10) Pub. No.: US 2021/0012585 A1
(43) Pub. Date: Jan. 14, 2021

(54) Camping Car Control System and Control Method Thereof

(71) Applicants: MKD Technology Inc., Hsinchu City (TW); MKDWELL (Jiaxing) Electronics Technology Co., Ltd., Jiaxing City (CN); MKDWELL LIMITED, Shanghai City (CN)

(72) Inventors: Ming Chia Huang, Hsinchu City (TW); Keng Cheng Lin, Hsinchu City (TW); Ching Wu Su, Hsinchu City (TW)

(73) Assignees: MKDWELL (Jiaxing) Electronics Technology Co., Ltd.; MKDWELL LIMITED; MKD Technology Inc.

(21) Appl. No.: 16/508,264

(22) Filed: Jul. 10, 2019

(51) Int. Cl. G07C 5/00; H04L 29/08; H04W 4/40

(52) U.S. Cl. CPC G07C 5/008; H04L 67/12; G05D 1/0088; G05D 2201/0213; H04W 4/40

(57) ABSTRACT

A control system for a camping car and a control method thereof are provided. The control system is connected to at least a CAN-bus formed by a plurality of body units in the camping car, and includes: a sensing control center module, a central computation processing module, a server, at least an electronic control device, and a smart screen. The control method includes: a connection step, an operation selection step, a transmission step, an operation processing step, and a control step. The present invention uses the modules, the server, and the device in collaboration, and in conjunction with the steps to achieve a variety of choices in the operation mode, thereby improving the accuracy of control, diagnosis, and warning, as well as a unified control platform, high degree of automation, able to achieve remote control and automatic alarm.

### BACKGROUND OF THE INVENTION

### 1. Field of the Invention

The present invention relates generally to a camping car internal control system, and more particularly to a camping car control system and control method thereof.

### 2. The Prior Arts

As the economy grows in rapid development, the use of RVs (i.e., camping cars) is more and more widespread. The appearance of RVs expands people's activities. The RVs enable the users to be close to nature, to carry out adventurous activities to reduce the stress from the work. The design of the RV is more unique than the ordinary residential house. As the RV travels in the wild, the safety factor is a major concern as the roads are rugged and the possible animal attack at night.

However, today's RVs, also known as “homes on wheels”, have both the “home” and “car” functions, but the main attributes are still cars, i.e., a vehicle that moves and has the basic facilities necessary for home, as well as able to park at any beaches, lakeshores, grasslands, hillsides, forests away from the city, and at the same time accommodate a city life. The home facilities on the car include: bedding, stove, refrigerator, cabinet, sofa, dining table and chair, washing facilities, air conditioner, TV, stereo and other furniture and appliances. The car is divided into the driving area, living area, bedroom area, sanitary area, kitchen area, and so on. In short, the RV is a trendy product that combines “clothing, food, living and traveling” to realize “travel in life, life in travel”.

In addition, the current RVs in the market are equipped with a series of home facilities such as a living room, a washroom and a dining area, which allows people to rest not only in the RV but also to cook. However, the facilities in these RVs are independently operated, individually controlled, and are without a unified control platform. When one of the facilities has safety problems, it is impossible to control the safety of other facilities in the entire car in time; in other words, although the car is generally equipped with lighting, power window, power curtain, power chai and other electric home appliances, the extent of automation of RVs is not high, and only the people in the RV can control the facilities. The lack of a unified control platform and remote control may also result in the loopholes in the RV security and monitoring.

Even more important is that the RVs have a variety of smart devices, and different devices require different controllers, such as buttons, remote controls, touch screens, and so on. A complex control system causes inconvenience to the user experience, and each control system corresponding to each device to be controlled needs to be correspondingly provided with a computational processor or circuit. More specifically, when an in-car device encounters a problem, it is difficult to inquire and perform immediate diagnosis and necessary processing. Also, the internal wiring of the RV is complicated, which increases the repair difficulty.

Furthermore, the RV must be equipped with all the basic facilities at home; for example, water and electricity; there are not only safety issues, but also storage and sustaining resource issues; while water tanks and the battery may solve the storage problem, how to find resource in time before running out becomes an important issue.

Another serious problem in the RV nowadays is when the driver wants to retrieve the in-car information on the CAN-bus inside the RV (such as engine status, water tank temperature, air conditioning status, tire pressure detection, odometer, acceleration sensor, the steering meter, the fuel gauge, the ABS, the AirBag, etc.), the drive must go through the above vehicle diagnostic system, and then can connect the circuits to obtain the desired in-car information. The process is complicated, strict, and extremely difficult and inconvenient for the driver.

Therefore, the present invention is proposed to address the above-mentioned drawbacks.

### SUMMARY OF THE INVENTION

A primary objective of the present invention is to provide a camping car control system and a control method thereof. The system, through a computer equipped in a camping car, uses the operation method of issuing commands and a plurality of operation modes, such as, controlling a single or multiple units, so the commands sent can target a specific body unit to operate separately; therefore, the present invention provides diversified choices in the application of the operating mode, thereby improving the accuracy of control, diagnosis and warning.

To achieve the above objective, present invention provides a control system for a camping car, for connecting to at least a controller area network bus (CAN-bus) formed with a plurality of body units in a camping car, the control system comprising: a sensing control center module having a central sensing processing device and a plurality of sensors, the central sensing processing device being electrically connected to the sensors, and the sensors being respectively connected through signals to the body units to sense operation states of the body units for and to correspondingly generate at least a sensing feedback signal, and the sensors transmitting the sensing feedback signal to the central sensing processing device; a central computation processing module having a central computation processing unit, at least a wireless communication unit, at least a vehicle communication unit, at least a switch control unit and at least a light control unit, the central computation processing unit being electrically connected to the wireless communication unit, the vehicle communication unit, the switch control unit and the light control unit, and the central computation processing module being connected to the CAN-bus through signals, and further connecting to the body units and the sensing control center module; a server, connected to the wireless communication unit and the central sensing processing device through wireless signals, the server having a vehicle information integration platform, a vehicle data collection module, an information processing module and a human-machine interface module, the vehicle information integration platform system being connected to the vehicle data collection module, the information processing module and the human-machine interface module; at least an electronic control device, selecting a wireless signal to connect to one or any combination of the server, the central computation processing module and the sensing control center module; and a smart screen, connected to the central computation processing module and the sensing control center module via CAN-bus signal, and having a touch display screen and a graphic interface processing module.

Furthermore, the present invention further provides a control method for a camping car control system, which is applied to the above-described camping car control system, the camping car, the body units, and the CAN-bus, and the control method of the camping car control system comprises: a connection step, one of the wireless signals of the server or the wireless communication unit being connected to the electronic control device, and the smart screen connecting the central computation processing module and the sensing control center module via the CAN-bus signal; an operation selection step, the user generating at least an operation control information by using the electronic control device or the smart screen; a transmission step, the server or the wireless communication unit transmitting the operation control information to the central computation processing unit; a computation processing step, the central computation processing module performing a computation processing on the operation control information, and generating an executing command information; and a control step, the central computation processing unit transmitting the executing command information to at least a body unit to control the operation of the body unit.

The control system of the camping car and the control method thereof provided by the present invention are mainly through the cooperative operation of the sensing control center module, the central computation processing module, and the server in the control system of the camping car, and in collaboration with connection and operation of the electronic control device or the smart screen. By using the above control method to achieve, through a computer equipped in a camping car, using the operation method of issuing commands and a plurality of operation modes, such as, controlling a single or multiple units, so that the commands sent can target a specific body unit to operate separately; therefore, the present invention provides diversified choices in the application of the operating mode, thereby improving the accuracy of control, diagnosis and warning. The present invention also has the advantages of unified control platform, high degree of automation, remote control and automatic alarm.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram of a system in accordance with a preferred embodiment of the present invention;

FIG. 2 is a schematic diagram of a system architecture of a preferred embodiment of the present invention;

FIG. 3 is a block diagram showing a detailed system of a preferred embodiment of the present invention;

FIG. 4 is a schematic diagram of a physical system architecture in accordance with a preferred embodiment of the present invention;

FIG. 5 is a perspective view showing a central computation processing module in accordance with a preferred embodiment of the present invention;

FIG. 6 is an exploded perspective view showing a central computation processing module in accordance with a preferred embodiment of the present invention;

FIG. 7 is a schematic view showing the usage state of a preferred embodiment of the present invention;

FIG. 8 is a schematic view showing the usage state of a preferred embodiment of the present invention;

FIG. 9 is a schematic diagram of a human-machine interface according to a preferred embodiment of the present invention, which shows a main control interface displayed by the human-interface module on the electronic control device;

FIG. 10 is a schematic diagram of a human-machine interface of a preferred embodiment of the present invention, which shows a main control interface displayed on a smart screen after the cooperation of the human-machine interface module and the graphical interface processing module;

FIG. 11 is a schematic diagram of a human-machine interface according to a preferred embodiment of the present invention, which shows a context mode control interface displayed on a smart screen after the cooperation of the human-machine interface module and the graphical interface processing module;

FIG. 12 is a schematic diagram of a human-machine interface according to a preferred embodiment of the present invention, which shows a lighting system control interface displayed on a smart screen after the cooperation of the human-machine interface module and the graphical interface processing module;

FIG. 13 is a schematic diagram of a human-machine interface according to a preferred embodiment of the present invention, which shows is a schematic diagram of a human-machine interface according to a preferred embodiment of the present invention, which shows an energy control interface displayed on a smart screen after the cooperation of the human-machine interface module and the graphical interface processing module;

FIG. 14 is a schematic diagram of a human-machine interface according to a preferred embodiment of the present invention, which shows an electrical appliance control interface displayed on a smart screen after the cooperation of the human-machine interface module and the graphical interface processing module;

FIG. 15 is a schematic diagram of a human-machine interface according to a preferred embodiment of the present invention, which shows a water tank state interface displayed on a smart screen after the cooperation of the human-machine interface module and the graphical interface processing module;

FIG. 16 is a schematic diagram of a human-machine interface according to a preferred embodiment of the present invention, which shows a warning control interface displayed on a smart screen after the cooperation of the human-machine interface module and the graphical interface processing module;

FIG. 17 is a flowchart of a control method in accordance with a preferred embodiment of the present invention; and

FIG. 18 is a flowchart of a control method according to another preferred embodiment of the present invention.

### DETAILED DESCRIPTION OF THE PREFERRED EMBODIMENT

The accompanying drawings are included to provide a further understanding of the invention, and are incorporated in and constitute a part of this specification. The drawings illustrate embodiments of the invention and, together with the description, serve to explain the principles of the invention.

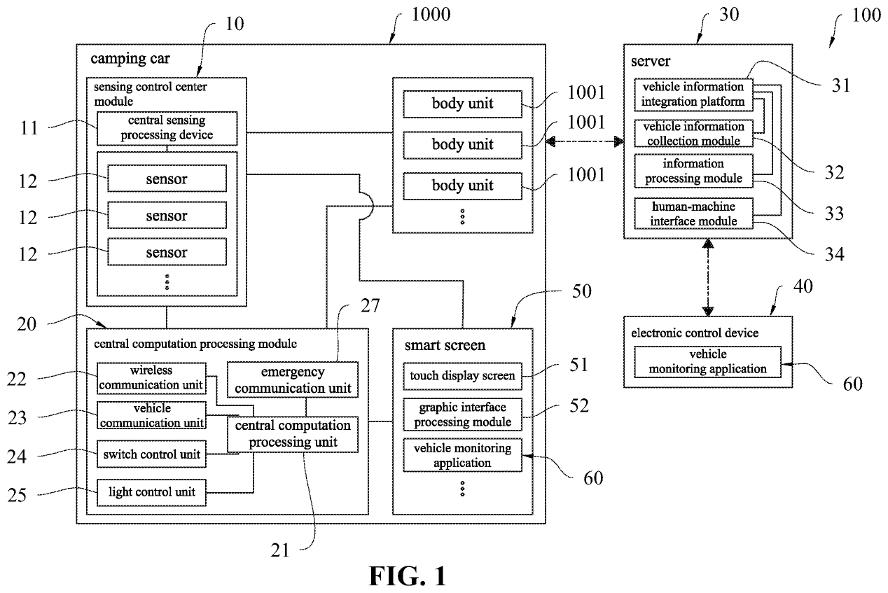

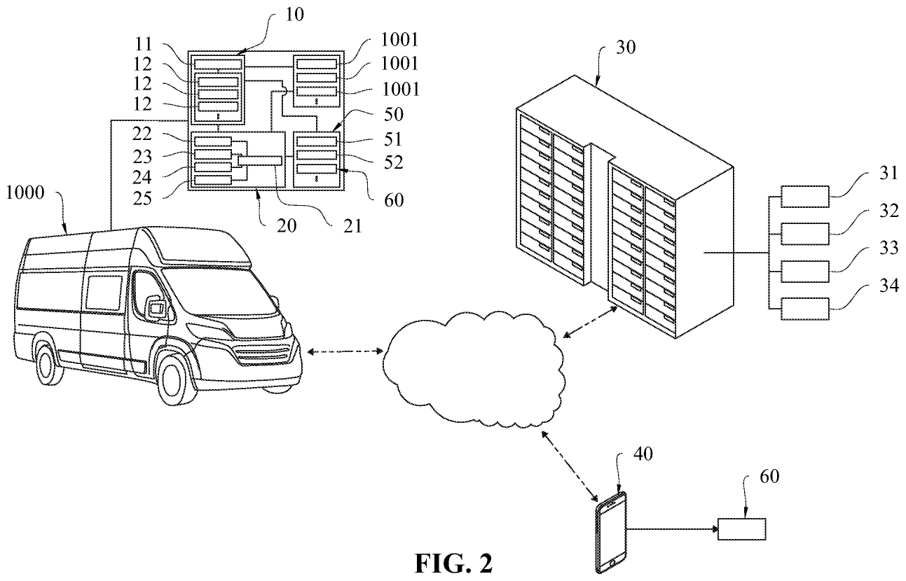

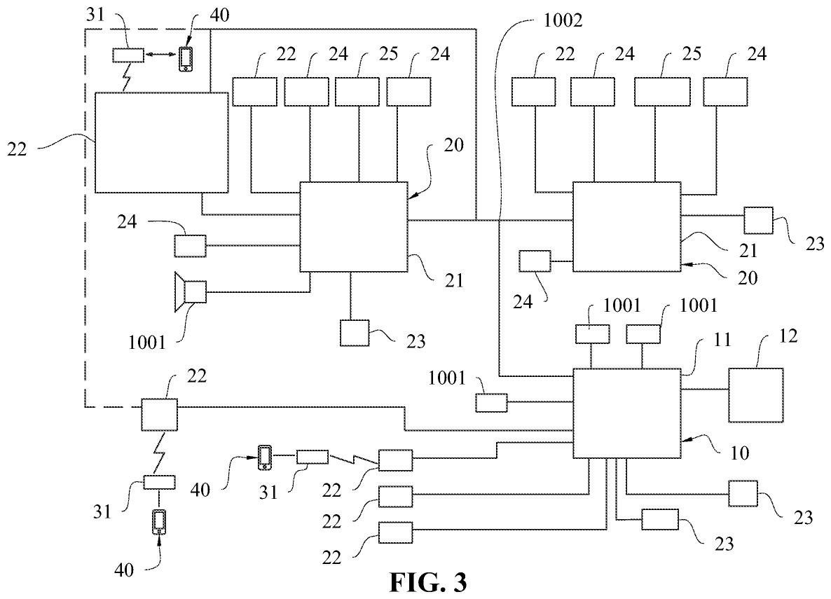

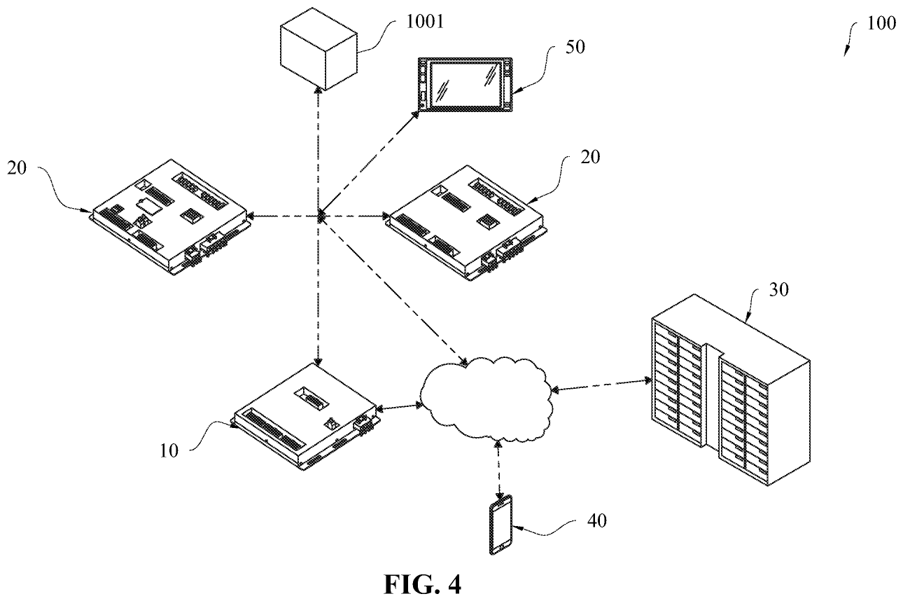

Referring to FIG. 1 and FIG. 2, as well as FIG. 3 and FIG. 4, there are shown a system block diagram, a system architecture diagram, the detailed system block diagram and the physical system architecture diagram of the preferred embodiment of the present invention, which disclose a camping car control system 100, which is connected to a plurality of controller area network buses (CAN-bus) 1002 formed by a plurality of body units 1001 of a camping car 1000. The plurality of CAN-buses 1002 are selected from one of a local communication network and a controller area network, or a combination thereof, and the camping car control system 100 comprises:

A sensing control center module 10 having a central sensing processing device 11 and a plurality of sensors 12, the central sensing processing device 11 being electrically connected to the sensors 12, and the sensors 12 being respectively connected through signals to the body units 1001 to sense operation states of the body units 1001 for and to correspondingly generate at least a sensing feedback signal, and the sensors 12 transmitting the sensing feedback signal to the central sensing processing device 11; in the present embodiment, the sensors 12 are respectively a fuel sensor, a power sensor, a button sensor, a switch sensor, a light sensor, an Ethernet connection device, a GPS positioning device, a suspended particle sensor, and 6-axis posture sensor, water tank water level sensor, human body sensor, temperature sensor, rain sensor, air quality sensor and smoke sensor, and so on.

A central computation processing module 20 having a central computation processing unit 21, at least a wireless communication unit 22, at least a vehicle communication unit 23, at least a switch control unit 24, at least a light control unit 25, and at least an emergency communication processing unit 27, the central computation processing unit 21 being electrically connected to the wireless communication unit 22, the vehicle communication unit 23, the switch control unit 24, the light control unit 25 and the emergency communication processing unit 27, and the central computation processing module 20 being connected to the CAN-bus 1002 through signals, and further connecting to the body units 1001 and the sensing control center module 10.

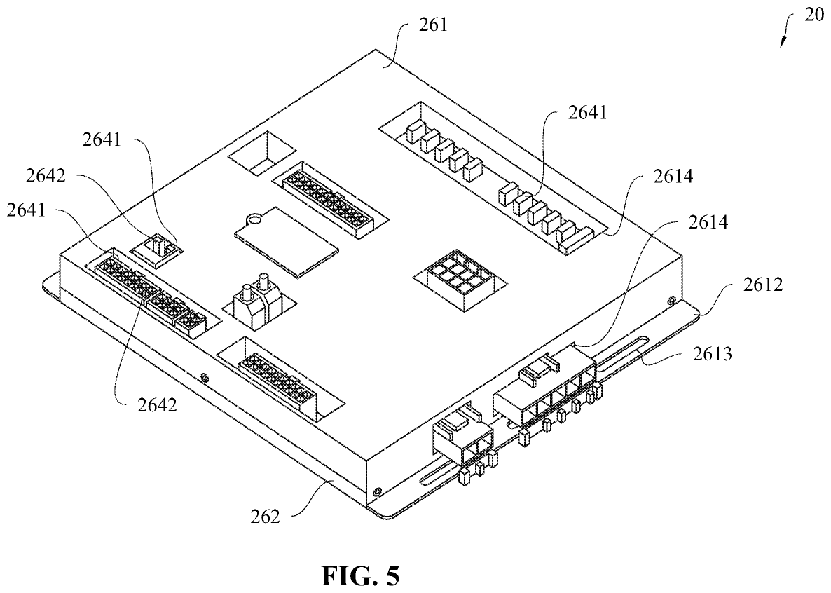

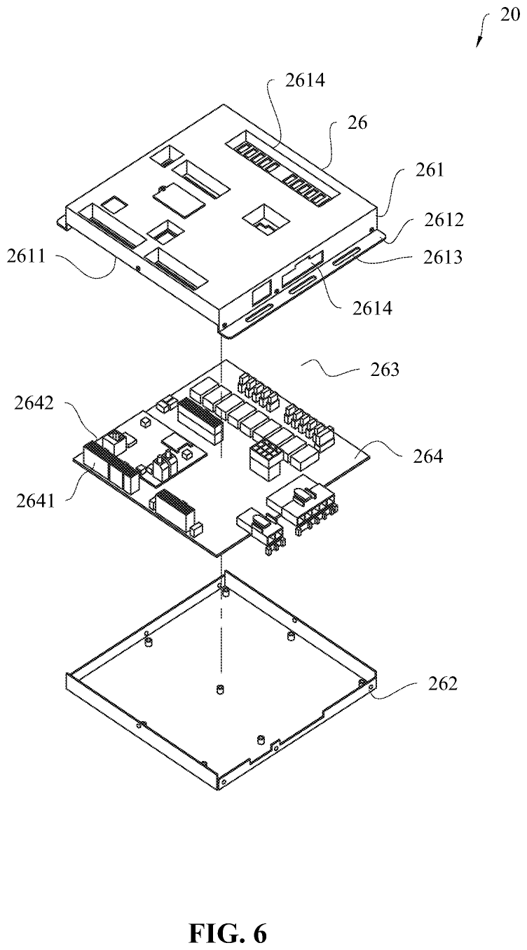

In the present embodiment, the overall architecture of the central computation processing module 20 is shown in FIG. 1, FIG. 5 and FIG. 6. The central computation processing module 20 has a housing assembly 26, and the housing assembly 26 is provided with a plurality of through holes 2614. The inside of the housing assembly 26 is provided with at least a circuit board 264. The circuit board 264 is provided with the central computation processing unit 21, the wireless communication unit 22, and the vehicle communication unit 23, the switch control unit 24 and the light control unit 25. The circuit board 264 is provided with a plurality of signal connectors 2641, and the signal connectors 2641 are correspondingly disposed through the through holes 2614. The signal connectors 2641 have a plurality of terminal holes 2642.

In terms of the hardware structure of the central computation processing module 20, as shown in FIG. 6, the housing assembly 26 comprises an outer casing 261 and a bottom casing 262, and the outer casing 261 and the bottom casing 262 are connected to form an accommodation space 263. The accommodation space 263 is provided with the circuit board 264. The outer casing 261 has a receiving groove 2611. The peripheral edge of the receiving groove 2611 extends outward to form two corresponding fixing pieces 2612, and the fixing pieces 2612 are parallel to the outer side surface of the outer casing 261. The fixing pieces 2612 are spaced apart and provided with a plurality of connecting holes 2613, and the connecting holes 2613 are used for a plurality of fixing members (not shown, for example, a screw) to be fixed in the camping car 1000. The through holes 2614 are respectively disposed in the bottom of the receiving groove 2611 and the inner peripheral wall thereof. In the present embodiment, the outer casing 261 has a shape of a rectangular box, and the fixing pieces 2612 are parallel to the outer side surface (i.e., the top side surface) of the outer casing 261, and the outer casing 261 covers the bottom casing 262; therefore, the overall size of the housing assembly 26 is only the outer casing 261, so the central computation processing module 20 completely uses the outer volume of the outer casing 261. In other words, when the central computation processing module 20 is assembled and disposed in the camping car 1000, no more space is occupied, and the connecting holes 2613 of the fixing pieces 2612 also provide a relatively stable and convenient assembly.

It should be further noted that when the actual entity of the present invention is installed in the camping car 1000, the camping car control system 100 has two central computation processing modules 20, as shown in FIG. 3 and FIG. 4, that is, one central computation processing module 20 is for primary computation processing, and the other central computation processing module 20 is for auxiliary computation processing. In addition, the present invention can use a single central computation processing module 20 to connect directly to the body units 1001 and the sensing control center module 10 to perform computation processing on information. Therefore, the present embodiment takes two as an example, but is not limited to the following implementation of the present invention.

In addition, the auxiliary central computation processing module 20 in the present embodiment does not comprise the wireless communication unit 22 and the vehicle communication unit 23, and the auxiliary central computation processing module 20 uses the wireless communication unit 22 and the vehicle communication unit 23 of the primary central computation processing module 20.

A server 30, connected to the wireless communication unit 22 and the central sensing processing device 11 through wireless signals, the server 30 having a vehicle information integration platform 31 a vehicle data collection module 32, an information processing module 33 and a human-machine interface module 34, the vehicle information integration platform 31 being connected to the vehicle data collection module 32, the information processing module 33 and the human-machine interface module 34. Also, it should be noted that the sensors 12 not only transmit the sensing feedback signal to the central sensing processing device 11, but the central sensing processing device 11 also wirelessly transmits the sensing feedback signal to the vehicle information integration platform 31 and the vehicle data collection module 32 of the server 30.

At least an electronic control device 40, selecting a wireless signal to connect to one or any combination of the server 30, the central computation processing module 20 and the sensing control center module 10; in the present embodiment, the electronic control device 40 comprises at least a vehicle monitoring application 60. The electronic control device 40 is connected to the vehicle information integration platform 31 by the vehicle monitoring application 60. The electronic control device 40 is selected from one of the smart phones, tablet PC, and notebook PC, and the present embodiment uses a smart phone as an example. In addition, the electronic control device 40 uses a signal selected from a group of wireless communication protocols consisting of Bluetooth, infrared (IR), 3G mobile communication, 4G mobile communication, wireless local area network (Wi-Fi), wireless local area network (WLAN) and 5G mobile communication to connect to the vehicle information integration platform 31 of the server 30; and a smart screen 50, connected to the central computation processing module 20 and the sensing control center module 10 via a signal of CAN-bus 1002, and having a touch display screen 51 and a graphic interface processing module 52; in the present embodiment, the smart screen 50 stores at least a vehicle monitoring application 60. The smart screen 50 is connected to the CAN-bus 1002 by the vehicle monitoring application 60.

Furthermore, the body unit 1001 is one of an electric awning, a heater, a heat exchanger solenoid valve, a control switch, a water pump, a water tank, a generator, a battery, an electric motor, a refrigerator, a satellite antenna, an exhaust fan, a window opening and closing device, a door opening and closing device, a lighting controller, a lamp, a drawer storage, a wireless communication device, a buzzer, an infrared transmitter, a current detecting device, an Ethernet connection device, a computer, an air conditioning unit, and so on.

In addition, in the present embodiment, the sensing control center module 10 stores at least a detection value information corresponding to the body unit 1001, and the sensor 12 senses the operation state of the body unit 1001 and correspondingly generates at least a sensing feedback signal. When the sensing feedback signal generated by the sensing control center module 10 does not match the detection value information of the sensed body unit 1001, the sensing control center module 10 sends at least a warning signal to the server 30 and the smart screen 50, and then the server 30 forwards the warning signal to the electronic control device 40.

In addition, in the embodiment, the wireless signal connection mode of the wireless communication unit 22 of the central computation processing module 20 is selected from one of the wireless signal connection with the server 30 and the intermediate wireless signal transmissions between the electronic control device 40 and the server 30, or any combination thereof; that is, the wireless communication unit 22 is configured to directly connect the central processing unit 20 to the wireless signal transmission of the server 30, or share the wireless signal with the electronic control device 40 for the electronic control device 40 to connect to the server 30 for wireless signal transmission.

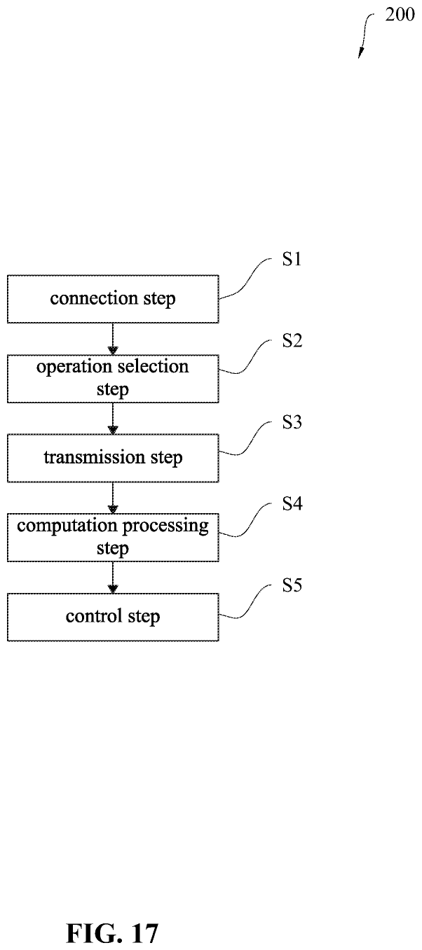

Refer to FIG. 1, FIG. 2 and FIG. 17 for a system block diagram, a schematic diagram of a system architecture, and a control method 200 according to a preferred embodiment of the present invention. Based on the control system of the camping car, a control method 200 for the camping car control system is further provided, which is applied to the camping car control system 100, the camping car 1000, the body unit 1001 and the CAN-bus 1002. The control method 200 of the camping car control system comprises:

A connection step S1, one of the wireless signals of the server 30 or the wireless communication unit 22 being connected to the electronic control device 40, and the smart screen 50 connecting the central computation processing module 20 and the sensing control center module 10 via a signal of the CAN-bus 1002.

An operation selection step S2, the user generating at least an operation control information by using the electronic control device 40 or the smart screen 50.

A transmission step S3, the server 30 or the wireless communication unit 22 transmitting the operation control information to the central computation processing unit 21.

A computation processing step S4, the central computation processing module 20 performing a computation processing on the operation control information, and generating an executing command information.

A control step S5, the central computation processing unit 21 transmitting the executing command information to at least a body unit 1001 to control the operation of the body unit 1001.

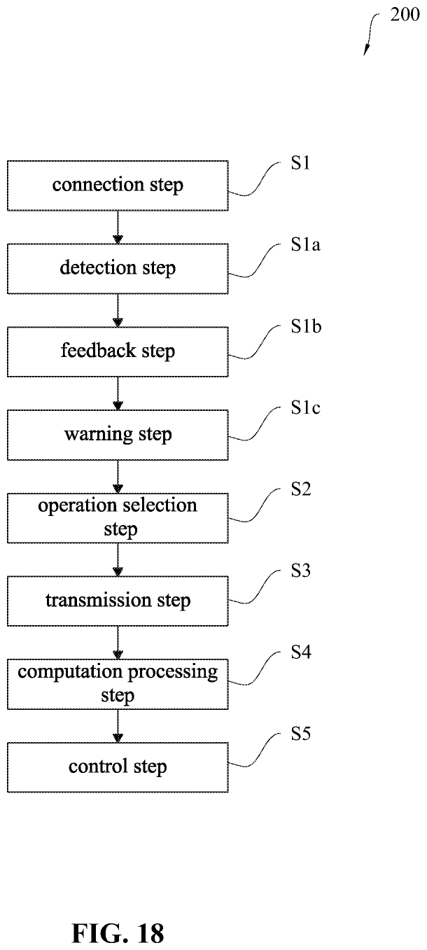

Also refer to FIG. 18, which shows a flowchart of the control method of another preferred embodiment of the present invention. The additional detection step S1a, Feedback step S1b and warning step S1c are added between the connection step S1 and the operation selection step S2, wherein:

In the detection step S1a, the sensors 12 are respectively connected through signal to the body unit 1001 and used to sense the operation state of the body unit 1001.

In the feedback step S1b, the sensors 12 sense the operation state of the body unit 1001 to further generate at least a sensing feedback signal, and the sensors 12 transmit the sensing feedback signal to the central sensing processing device 11.

In the warning step S1c, the sensing control center module 10 stores at least a detection value information corresponding to the body unit 1001, and the sensor 12 generates a sensing feedback signal when sensing the operation state of the body unit 1001. When the sensing control center module 10 is unable to match the sensing feedback signal with the detection value information of the body unit 1001 being sensed, the sensing control center module 10 transmits at least a warning signal to the server 30 and the smart screen 50, and the server 30 forwards the warning signal to the electronic control device 40. The warning signal is one of text information and voice information, or a combination thereof.

For further understanding the structural features of the present invention, the application of the technical means, and the desired effect of the present invention, the manner of use of the present invention will be described so that the present invention may be more deeply and specifically understood as follows:

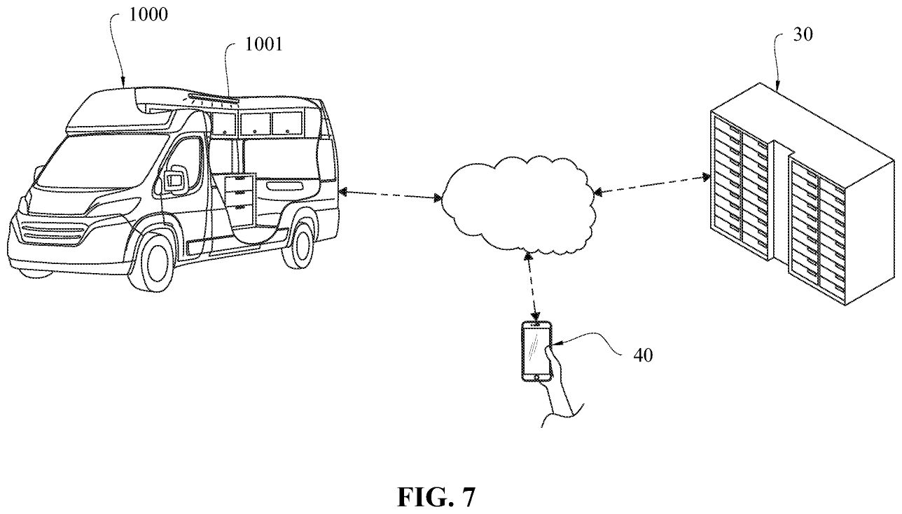

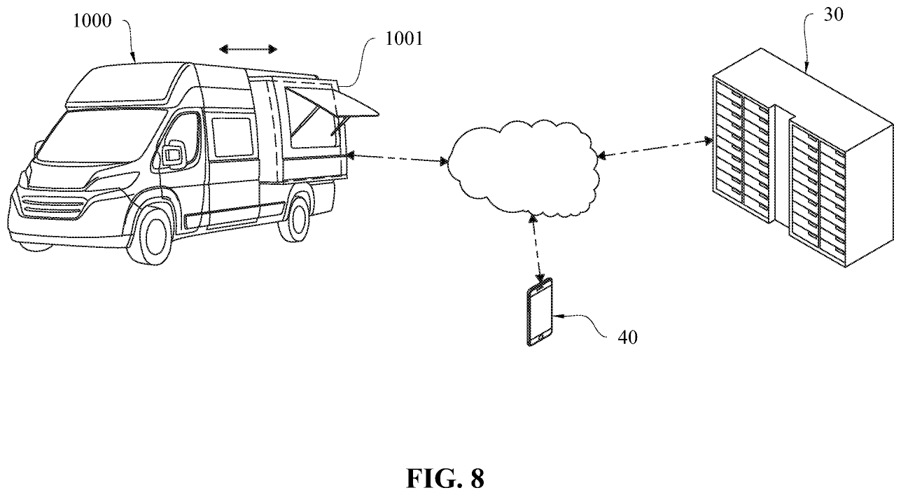

Referring to FIG. 1 and FIG. 2, together with FIG. 7 and FIG. 8, for a system block diagram, a schematic diagram of a system architecture, and a schematic diagram of a state of use according to a preferred embodiment of the present invention. During usage, the present invention mainly uses cooperation of the sensing control center module 10, the central computation processing module 20, and the server 30, and connection operation of the electronic control device 40 or the smart screen 50 in the camping car control system 100, as well as uses the above-described control method, so that the sensing control center module 10 senses the operation state of the body unit 1001, and the central computation processing module 20 is used to control the operation of the body unit 1001. Moreover, the server 30 is connected to the wireless communication unit 22 and the central sensing processing device 11 by wireless signals, so that the electronic control device 40 can control the unit 1001 and retrieve the operation state of the body unit 1001 through the signals of the vehicle information integration platform 31 of the server 30; in addition, the present invention can also be connected to the CAN-bus 1002 via the vehicle monitoring application 60 by using the smart screen 50 to control the operation of the body unit 1001 and retrieve the operation state of the body unit 1001.

More specifically, the present invention, through the body unit 1001 (here referring to an in-vehicle computer) equipped in a camping car 1000, uses the operation method of issuing commands and a plurality of operation modes, such as, controlling a single or multiple body units 1001, so that the commands sent can target a specific body unit 1001 to operate separately; therefore, the present invention provides diversified choices in the application of the operating mode, thereby improving the accuracy of control, diagnosis and warning. The present invention also has the advantages of unified control platform, high degree of automation, remote control and automatic alarm.

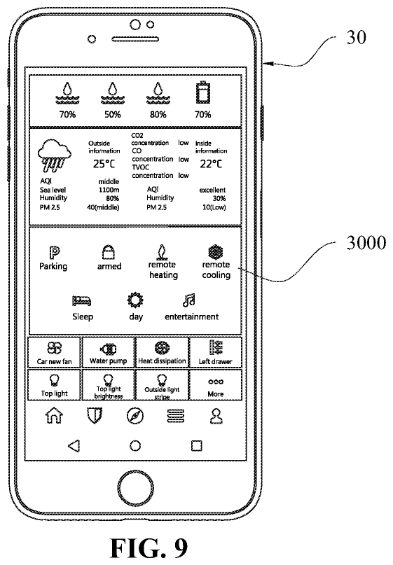

Refer to FIG. 17 and FIG. 9 for a flowchart of a control method 200 according to a preferred embodiment of the present invention and a schematic diagram of a human-machine interface displayed on the electronic control device 40. As shown in FIG. 9, the electronic control device 40 is connected to the vehicle information integration platform 31 of the server 30 by wireless communication, so as to obtain the main control human-machine interface 300 generated by the human-machine interface module 34. As shown in the interface 300, the electronic control device 40 (i.e., the smart phone) can directly transmit the control command to the vehicle information integration platform 31, or receive the operation information of the body unit 1001 and the sensing information of the sensors 12; more specifically, there are a variety of options for user mode of operation, which in turn increases the accuracy of control, diagnostics, and alarming, as well as ease of use.

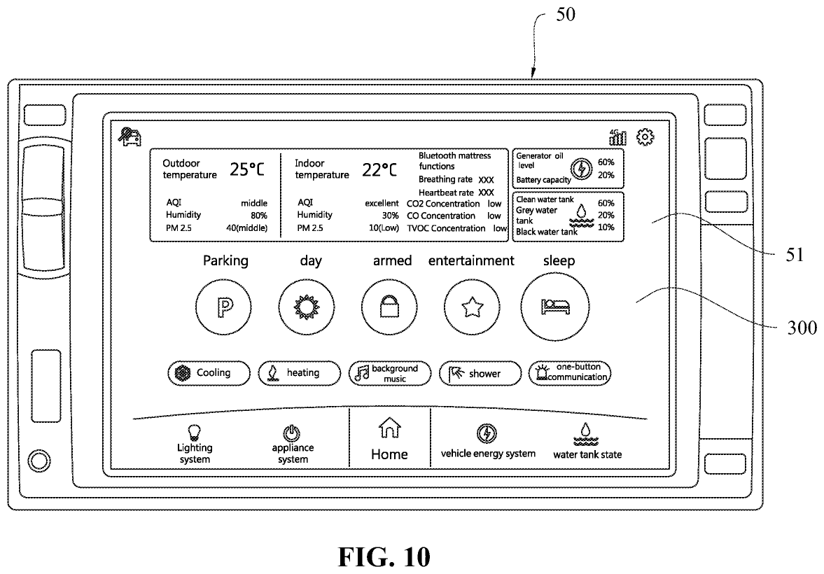

Refer to FIG. 17, and FIG. 10 to FIG. 16 for flowcharts of a control method 200 according to a preferred embodiment of the present invention and a human-machine interface diagram displayed on the smart screen 50, wherein:

FIG. 10 shows a main control interface 300 displayed on the smart screen 50 after the cooperation of the human-machine interface module 34 and the graphical interface processing module 52. The smart screen 50 can directly connect to the CAN-bus 1002, and in conjunction with the main human-machine interface 300 generated by the graphic interface processing module 52, the user can touch the touch display screen 51 to directly transmit control commands to the central computation processing module 20 or the sensing control center module 10, or receive operation information of the body unit 1001 and sensing information of the sensors 12; more specifically, the present invention provides a variety of options for the user in the application of the operation modes, which in turn improves the accuracy of control, diagnostics and warnings, as well as ease of use.

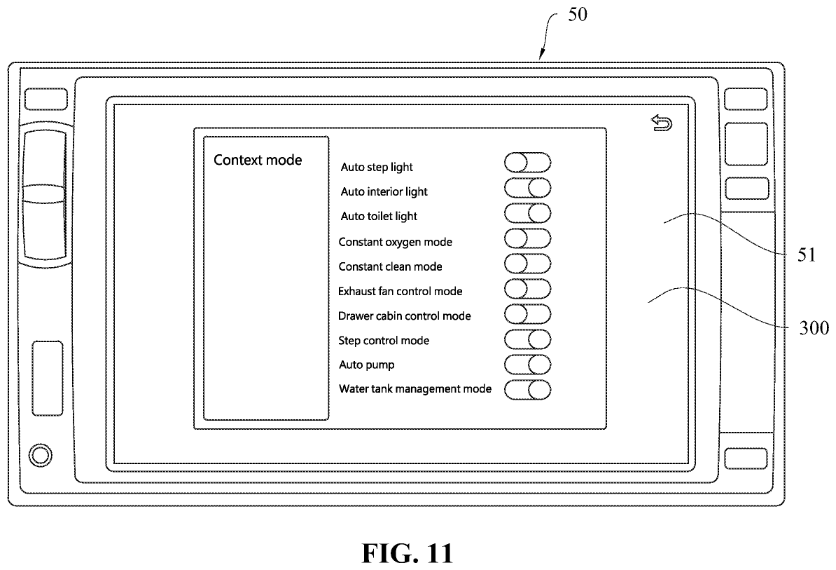

FIG. 11 is a context mode control interface 300 displayed on the smart screen 50 after the cooperation of the human-machine interface module 34 and the graphical interface processing module 52. The user can control the touch display screen 51 to control the context mode of the body unit 1001 (i.e., multiple lamps, fans, pumps, etc. inside and outside the vehicle) in the camping car 1000.

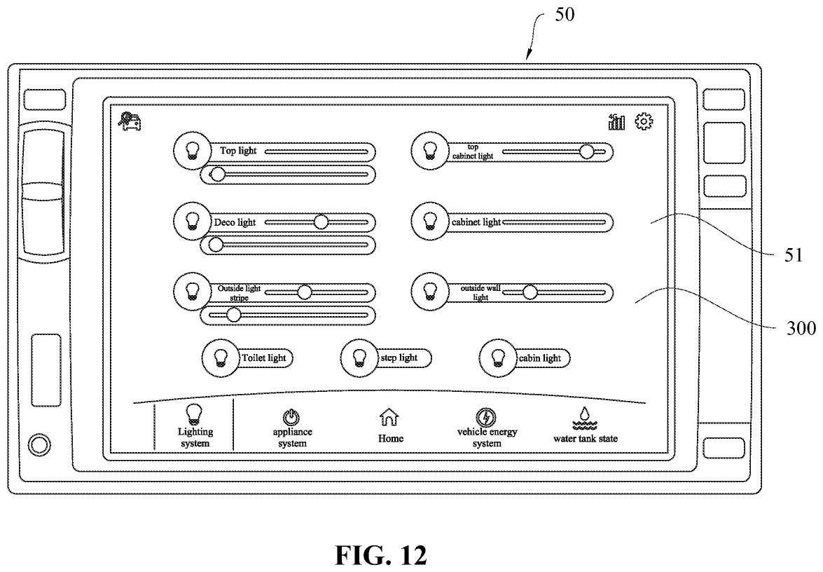

FIG. 12 is a lighting system control interface 300 displayed on the smart screen 50 after the cooperation of the human-machine interface module 34 and the graphic interface processing module 52. The user can control the touch display screen 51 to control the brightness, color or ON/OFF mode of the lights of the body unit 1001 (i.e., the plurality of lamps in the vehicle lighting system) in the camping car 1000.

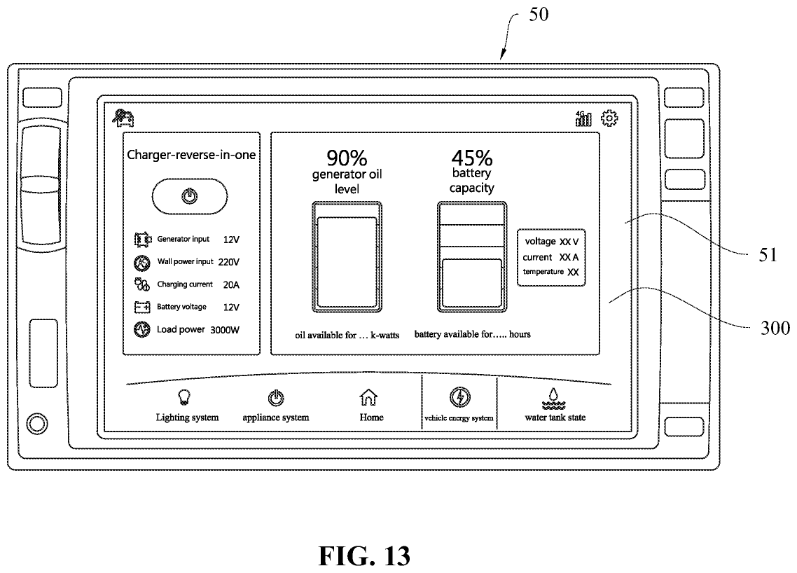

FIG. 13 shows an energy system control interface 300 displayed on the smart screen 50 after the cooperation of the human-machine interface module 34 and the graphical interface processing module 52. The user can touch the touch display screen 51 to know the operation state of the body unit 1001 (i.e., the vehicle energy system) in the camping car 1000, and the ON/OFF of the body unit 1001 can be controlled.

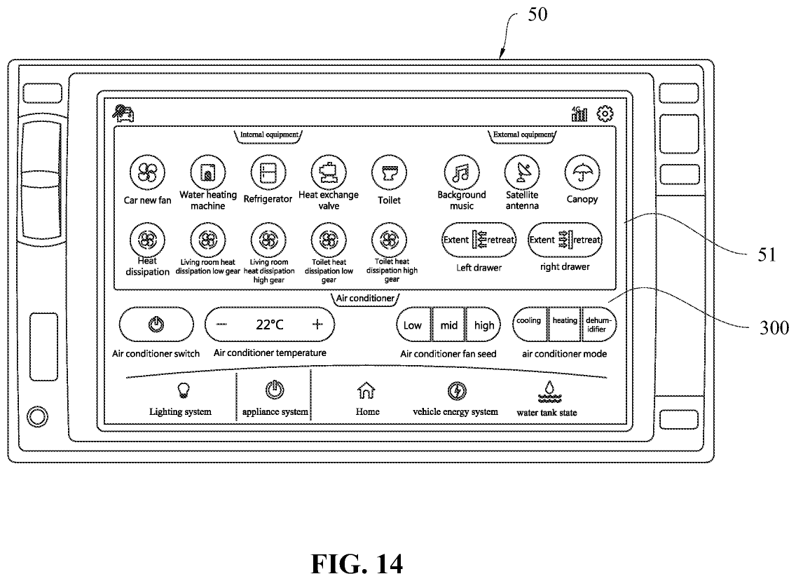

FIG. 14 shows an electrical appliance system control interface 300 displayed on the smart screen 50 after the cooperation of the human-machine interface module 34 and the graphical interface processing module 52. The user can touch the touch display screen 51 to know the operation state of the body unit 1001 (i.e., the electrical appliance system) in the camping car 1000, and controlling the ON/OFF of the body unit 1001 and various operational modes, for example, temperature control, humidity control, music On/OFF control, fan speed control, and so on.

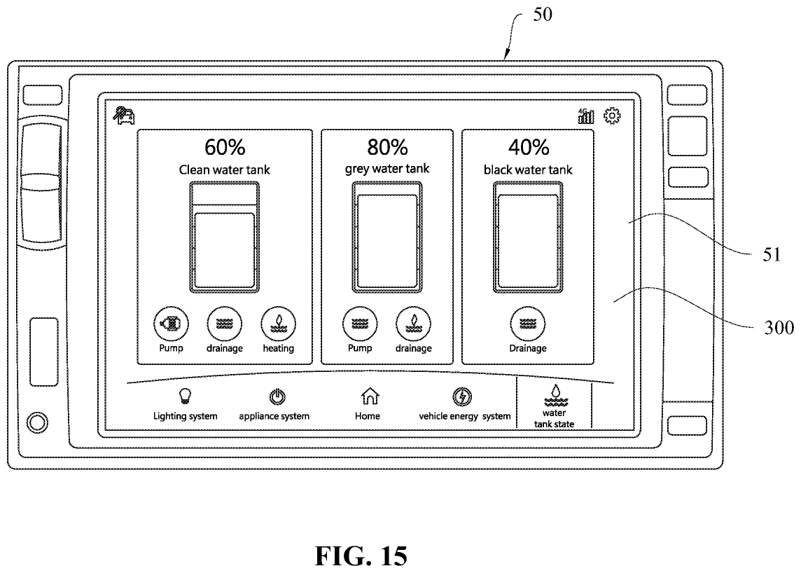

FIG. 15 shows a water tank state interface 300 displayed on the smart screen 50 after the cooperation of the human-machine interface module 34 and the graphic interface processing module 52. Since there are three water tanks in the camping car 1000, a clean water tank is for storing clean water, a gray water tank for storing the water flowing out of the sink, and a black water tank for the sewage of the toilet; therefore, the user can touch the touch display screen 51 to know the current storage capacity of the clean water tank, the gray water tank and the black water tank. In addition, the user can also control the drainage and heating of the clean water tank and the gray water tank, and the black water tank is only for drainage control.

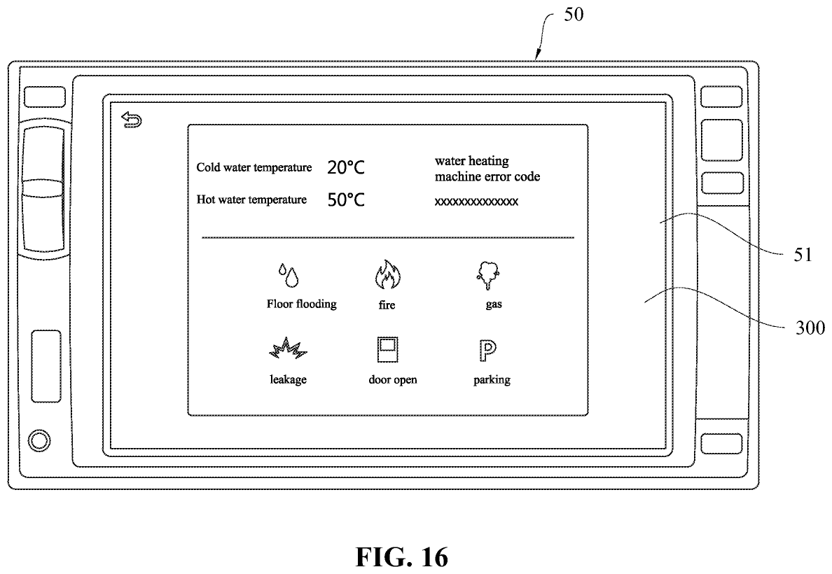

FIG. 16 is warning interface 300 displayed on the smart screen 50 after the cooperation of the human-machine interface module 34 and the graphic interface processing module 52. When one or more of the body units 1001 malfunction or show abnormal states, the central computation processing module 20 and the sensing control center module 10 cooperate to transmit at least a warning message to the smart screen 50, and the graphic interface processing module 52 graphically presents a warning. The interface 300 is provided for the user to quickly know the fault or abnormal body unit 1001 of the current camping car 1000 and immediately act accordingly.

It is worth noting that when the present invention is in the state of no-reception area in the mountains, the electronic control device 40 selects one from a group of the wireless communication protocols consisting of wireless local area network (Wi-Fi), wireless local area network (WLAN), ZigBee, Z-wave, and short-range wireless communication (NFC) or a combination thereof to connect to the wireless communication unit 22 of the central computation processing module 20 or the sensing control center module 10. More specifically, the electronic control unit 40 can directly and quickly intercept the operation information of the body unit 1001 without using the server 30.

It is worth noting that the electronic control device 40 serves as an important human-computer interaction means in the smart system of the entire camping car 1000, and the vehicle monitoring application 60 assumes a very important role. The user's electronic control device 40 can view the state of the vehicle, one-button deployment and retracking deployment, parking, switching the context mode, etc., and can also separately control different devices in the car, accept notifications sent by the smart system, and so on.

Hereafter, the features and expected efficacy of the present invention are stated as follows:

In the control system 100 of the camping car and the control method 200 thereof of the present invention, the sensing control center module 10 senses the operation state of the body unit 1001, the central computation processing module 20 is used to control the operation of the body unit 1001, and the server 30 is connected to the wireless communication unit 22 and the central sensing device 11 by wireless signals, so that the electronic control device 40 can control the body unit 1001 and retrieve operation state of the body unit 1001 via the signals of the vehicle information integration platform 31 of the server 30. The smart screen 50 is connected to the CAN-bus 1002 by the vehicle monitoring application 60 for controlling the body unit 1001 and the capturing operation state of the body unit 1001.

The present invention has the following efficacy and technical effects:

First, the present invention, through the body unit 1001 (here referring to an in-vehicle computer) equipped in a camping car 1000, uses the operation method of issuing commands and a plurality of operation modes, such as, controlling a single or multiple body units 1001, so that the commands sent can target a specific body unit 1001 to operate separately; therefore, the present invention provides diversified choices in the application of the operating mode, thereby improving the accuracy of control, diagnosis and warning. The present invention also has the advantages of unified control platform, high degree of automation, remote control and automatic alarm.

Second, the invention has a unified control platform, high degree of automation, and can realize the effects of remote control and automatic alarm.

Third, the present invention adopts communication and data exchange technology, and can automatically adjust and control various lighting systems, electrical systems, energy systems, water tanks, and vehicle operating systems in the camping car 1000 without excessive human intervention. As such, the camping car 1000 is more comfortable to live in, and can monitor the internal situation of the camping car 1000 at any time. When a part of facilities has potential safety hazards, the invention can check the safety hazards in a timely manner.

Fourth, the present invention is capable of solving the drawback of the control system of the conventional camping car 1000 mentioned in the prior art, wherein it is necessary to provide a computation processor or circuit corresponding to each device to be controlled when an in-vehicle device is provided, as well as the difficulty to inquire and do immediate processing when the problem occurs, and the internal wiring of the RV is complicated, which increases the repair difficulty. More specifically, the present invention only requires a central computation processing module 20 and a sensing control center module 10 to integrate and control multiple body units 1001 in the vehicle, and can achieve simple layout and avoid cumbersome effects, and the user can control all the electronic devices of the vehicle, thereby reducing the complicated problems.

In summary, the present invention has excellent advancement and practicability in the same kind of products, and at the same time, the technical documents of such structures are investigated at home and abroad, and the same structure is not found in the literature. Therefore, the present invention already meets the patent requirements, and submits an application according to law.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A control system for a camping car, for connecting to at least a controller area network bus (CAN-bus) formed with a plurality of body units in the camping car, the control system comprising:
a sensing control center module having a central sensing processing device and a plurality of sensors, the central sensing processing device being electrically connected to the sensors, and the sensors being respectively connected through signals to the body units to sense operation states of the body units for and to correspondingly generate at least a sensing feedback signal, and the sensors transmitting the sensing feedback signal to the central sensing processing device;
a central computation processing module having a central computation processing unit, at least a wireless communication unit, at least a vehicle communication unit, at least a switch control unit and at least a light control unit, the central computation processing unit being electrically connected to the wireless communication unit, the vehicle communication unit, the switch control unit and the light control unit, and the central computation processing module being connected to the CAN-bus through signals, and further connecting to the body units and the sensing control center module;
a server, connected to the wireless communication unit and the central sensing processing device through wireless signals, the server having a vehicle information integration platform, a vehicle data collection module, an information processing module and a human-machine interface module, the vehicle information integration platform system being connected to the vehicle data collection module, the information processing module and the human-machine interface module;
at least an electronic control device, selecting a wireless signal to connect to one or any combination of the server, the central computation processing module and the sensing control center module; and
a smart screen, connected to the central computation processing module and the sensing control center module via CAN-bus signal, and having a touch display screen and a graphic interface processing module;
wherein the sensing control center module sensing the operation states of the body units, and the central computation processing module being used to control the operation of the body units, and the server being connected to the wireless communication unit and the central sensing processing device via wireless signals so that the electronic control device being able to control the body units and retrieve the operation states of the body units via the vehicle information integration platform signal of the server.

2. The control system according to claim 1, wherein the central computation processing module comprises a housing assembly, and the housing assembly is provided with a plurality of through holes; the inside of the housing assembly is provided with at least a circuit board, and the circuit board is provided with the central computation processing unit, the wireless communication unit, and the vehicle communication unit, the switch control unit and the light control unit; the circuit board is provided with a plurality of signal connectors, and the signal connectors are correspondingly disposed through the through holes and the signal connectors have at least a terminal hole.

3. The control system according to claim 2, wherein the housing assembly comprises an outer casing and a bottom casing, and the outer casing and the bottom casing are connected to form an accommodation space and the accommodation space is provided with the circuit board; the outer casing has a receiving groove, and the peripheral edge of the receiving groove extends outward to form two corresponding fixing pieces; the fixing pieces are parallel to outer side surface of the outer casing, and the fixing pieces are spaced apart and provided with a plurality of connecting holes; the connecting holes are used for a plurality of fixing members to be fixed in the camping car; the through holes are respectively disposed in the bottom of the receiving groove and the inner peripheral wall thereof.

4. The control system according to claim 1, wherein the body unit is one of an electric awning, a heater, a heat exchanger solenoid valve, a control switch, a water pump, a water tank, a generator, a battery, an electric motor, a refrigerator, a satellite antenna, an exhaust fan, a window opening and closing device, a door opening and closing device, a lighting controller, a lamp, a drawer storage, a wireless communication device, a buzzer, an infrared transmitter, a current detecting device, an Ethernet connection device, a computer, and an air conditioning unit; and the sensors are one or any combination of a fuel sensor, a power sensor, a button sensor, a switch sensor, a light sensor, an Ethernet connection device, a GPS positioning device, a suspended particle sensor, and 6-axis posture sensor, water tank water level sensor, human body sensor, temperature sensor, rain sensor, air quality sensor and smoke sensor.

5. The control system according to claim 1, wherein the electronic control device uses a signal selected from a group of wireless communication protocols consisting of Bluetooth, infrared (IR), 3G mobile communication, 4G mobile communication, wireless local area network (Wi-Fi), wireless local area network (WLAN) and 5G mobile communication to connect to the server.

6. The control system according to claim 1, wherein the electronic control device selects one from a group of the wireless communication protocols consisting of wireless local area network (Wi-Fi), wireless local area network (WLAN), ZigBee, Z-wave, and short-range wireless communication (NFC) or a combination thereof to connect to the wireless communication unit of the central computation processing module or the sensing control center module; the wireless signal connection mode of the wireless communication unit is selected one or any combination from the wireless signal connection with the server, or as an intermediate wireless signal transmission between the electronic control device and the server.

7. The control system according to claim 1, wherein the electronic control device and the smart screen system have stored at least a vehicle monitoring application program; the electronic control device is connected to the vehicle information integration platform by the vehicle monitoring application, and the smart screen uses the vehicle monitoring application to connect to the CAN-bus.

8. The control system according to claim 1, wherein the central sensing processing device receives the sensing feedback signal and transmits to the central computation processing module and the server; the sensing control center module stores at least a detection value information corresponding to the body unit, and the sensor senses the operation state of the body unit and correspondingly generates at least a sensing feedback signal; when the sensing feedback signal generated by the sensing control center module does not match the detection value information of the sensed body unit the, the sensing control center module sends at least a warning signal to the server and the smart screen, and the server forwards the warning signal to the electronic control device; the central computation processing module further comprises an emergency communication processing unit, and the emergency communication processing unit is connected to the central computation processing unit.

9. A control method applied to the control system according to claim 1, comprising:
a connection step, one of the wireless signals of the server or the wireless communication unit being connected to the electronic control device, and the smart screen connecting the central computation processing module and the sensing control center module via the CAN-bus signal;
an operation selection step, the user generating at least an operation control information by using the electronic control device or the smart screen; a transmission step, the server or the wireless communication unit transmitting the operation control information to the central computation processing unit;
a computation processing step, the central computation processing module performing a computation processing on the operation control information, and generating an executing command information; and
a control step, the central computation processing unit transmitting the executing command information to at least a body unit to control the operation of the body unit.

10. The control method according to claim 9, further comprising:
a detection step, the sensors being respectively connected through signal to the body unit and used to sense the operation state of the body unit;
a feedback step, the sensors sensing the operation state of the body unit to further generate at least a sensing feedback signal, and the sensors transmitting the sensing feedback signal to the central sensing processing device;
a warning step, the sensing control center module storing at least a detection value information corresponding to the body unit, and the sensor generating a sensing feedback signal when sensing the operation state of the body unit, when the sensing control center module being unable to match the sensing feedback signal with the detection value information of the body unit being sensed, the sensing control center module transmitting at least a warning signal to the server and the smart screen, and the server forwarding the warning signal to the electronic control device; the warning signal is one of text information and voice information, or a combination thereof.
